(19) United States
(12) Patent Application Publication
(10) Pub. No.: US 2006/0019699 A1
(43) Pub. Date: Jan. 26, 2006

(54) Method of uploading web blog in mobile communication terminal and system thereof

(75) Inventors: Sung June Chang, Seoul (KR); Sung Wook Kim, Seongnam-si (KR)

Correspondence Address: JONATHAN Y. KANG, ESQ.;LEE, HONG, DEGERMAN, KANG & SCHMADEKA, 14th Floor, 801S. Figueroa Street, Los Angeles, CA, 90017, US

(73) Assignee: LG Electronics Inc.

(21) Appl. No.: 11/177,906

(22) Filed: Jul. 7, 2005

(30) Foreign Application Priority Data
Jul. 8, 2004 (KR) 10-2004-0052896

(51) Int. Cl. H04M 1/00

(52) U.S. Cl. 455/552.1; 455/426.1

(57) ABSTRACT

A method of uploading a web blog in a mobile communication terminal and system thereof are disclosed, in which the web blog is composed and stored by off-line using the mobile communication terminal, in which the web blog is transmitted via a wireless connection to a computer, and by which the user's web blog can be uploaded to a web blog site. By selecting the upload of the web blog automatically or manually and by notifying a presence or non-presence of the upload completion to the user, the present invention facilitates the web blog to be uploaded within wireless Internet access, thereby enhancing convenience of using the mobile communication terminal.

### BACKGROUND OF THE INVENTION

1. Field of the Invention

The present invention relates to a method of uploading a web blog in a mobile communication terminal and system thereof, in which the web blog (web log) is written by off-line using the mobile communication terminal and by which the web blog can be uploaded using a computer.

2. Discussion of the Related Art

Recently, mobile communication terminals are globally supplied and evolving for its convergence. The mobile communication terminal, which is called a small PC nowadays, can implement various functions of inputting, generating and processing text, voice, video and the like as well as communications.

The complex and advanced functionality of the mobile communication terminal helps a user satisfy various kinds of his/her wants in real life without putting limitation on time and space.

In general, to collect and acquire data without time and space limitations and to manage and utilize the data systematically, the data is utilized on web via wireless Internet or is transferred to a system provided with a large storage volume instead of being managed and utilized using the limited resources of a personal mobile terminal.

Lately, an environment, which is called ‘Weblog’ or ‘Blog’, is widely utilized. Such an environment does not need difficult operational technique procedures including a complicated subscription to a conventional Internet site, Internet database management, home page preparation and the like, facilitates a user to have his/her own personalized web page, and enables the user to represent various kind of information by text or graphic. ‘Blog’, which is an abbreviation of ‘Web’ and ‘Log’, designates a personalized web site to which a normal user uploads columns, a voyage log, a travel diary, a covered article and the like according to a matter of his/her concern and interest.

It can be described that the weblog or blog is a new type media on Internet to be utilized as a personal media space evolving from a conventional personal homepage. The weblog or blog is advantageous in that various kinds of real-time information can be systematically and quickly stored in a personal memory storage each time by accessing a personalized web page with ease in a manner of arranging notes one by one neatly.

Meanwhile, since a wireless web browser (WAP/WML) is built in a mobile communication terminal, it is able to directly input an Internet address or domain name of a corresponding site or to access the corresponding side via a previously registered Internet address after having accessed Internet by driving the wireless web browser. Hence, all web sites on Internet can be accessed, whereby web blogs can be managed using the mobile communication terminal.

BBC (British Broadcasting Corporation) has covered a story that attention is paid to the web blog that is developed into MO-blog by expanding its domain via wireless communication equipments such as a mobile phone, PDA, etc. The MO-blog is a compound word of ‘mobile’ and ‘blog’.

Such an expansion of domain is attributed to the recent technical developments of enabling multimedia messaging services or photo transmissions and the like using wireless communication equipments. So, various mo-blog programs such as phone blog, many ware, wap blog and the like show up one after another. Theses programs enable users to upload texts or photos to blogs using mobile phones. And, the various blogs will be named ‘web blogs’ in the following.

A web blog upload method using a mobile communication terminal according to a related art is explained with reference to the attached drawing as follows.

FIG. 1 is a flowchart of a web blog upload method using a mobile communication terminal according to a related art.

Referring to FIG. 1, once a user selects an Internet access button, a mobile communication terminal transmits an Internet access request signal to a mobile communication network to access wireless Internet (S100).

In particular, once the user generates an Internet access request, the mobile communication terminal drives a wireless web browser and transmits the Internet access request signal to a network matching unit via a base station, base station controller and mobile switching controller belonging to the mobile communication network. The network matching unit mutually connects a wireless communication network and Internet by converting a protocol of the wireless communication network to Internet protocol, and a proxy enables the mobile communication terminal to access Internet by transmitting the Internet access request signal inputted via the network matching unit to a web server.

After having accessed the wireless Internet, if an access request signal for a web blog site is inputted by a user, the mobile communication terminal accesses the corresponding web blog site (S110). The user of the mobile communication terminal composes and inputs a specific drawing or sentence (S120). And, the inputted drawing or sentence is uploaded to the web blog site (S130). If receiving an Internet access end signal from the user, the mobile communication terminal terminates the Internet access (S140).

Namely, after the mobile communication terminal has accessed the user's web blog site in direct via the wireless Internet, the user composes or edits the specific drawings or sentences on the web blog site to upload.

However, the related art web blog upload method in the mobile communication terminal has the following problems.

First of all, since the web blog contents are uploaded from the mobile communication terminal that is being connected to the wireless Internet, the user has to pay a wireless Internet use charge.

Secondly, since the wireless Internet is accessed, radio resources are wasted.

Thirdly, the web blog using the mobile communication terminal is unlikely to be popular because of the charge according to the wireless Internet access.

### SUMMARY OF THE INVENTION

Accordingly, the present invention is directed to a method of uploading a web blog in a mobile communication terminal and system thereof that substantially obviates one or more problems due to limitations and disadvantages of the related art.

An object of the present invention is to provide a method of uploading a web blog in a mobile communication terminal and system thereof, by which the web blog composed by off-line can be uploaded using the mobile communication terminal without paying a wireless Internet use fee.

Another object of the present invention is to provide a method of uploading a web blog in a mobile communication terminal and system thereof, in which the web blog is composed, edited and stored on the mobile communication terminal, in which the stored web blog is transferred to a computer using local area wireless communications, and by which the web blog can be automatically or manually uploaded on Internet.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a web blog upload method using a mobile communication terminal according to the present invention includes the steps of composing and storing a web blog by off-line in the mobile communication terminal, searching for a target computer in the mobile communication terminal to be connected to the searched computer by wireless, transmitting web blog information to the computer connected to the mobile communication terminal by wireless, analyzing the web blog information received from the mobile communication terminal in the computer, and uploading the web blog by accessing a user's web blog site.

In another aspect of the present invention, a web blog upload method using a mobile communication terminal includes the steps of composing and storing a web blog by off-line in the mobile communication terminal, searching for a target computer in the mobile communication terminal to be connected to the searched computer by wireless, transmitting user's web blog information to the computer connected to the mobile communication terminal by wireless, analyzing the web blog information received from the mobile communication terminal in the computer and uploading the web blog by accessing a user's web blog site, and if the computer uploads the web blog, transmitting an upload completion message to the mobile communication terminal.

In a further aspect of the present invention, a web blog upload system includes a mobile communication terminal automatically transmitting user's web blog information composed by off-line to a target equipment by local area wireless communications, a computer uploading a web blog by receiving the web blog information from the mobile communication terminal to access a web bog site, and a web blog server providing the web blog side of the user to a plurality of bloggers.

Therefore, by composing user-specific interest and concern into the web blog (blog, log) by off-line in the mobile communication terminal and by uploading the composed web blog via a target computer automatically, the present invention prevents the waste of radio resources and enhances convenience in using the terminal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a flowchart of a web blog upload method using a mobile communication terminal according to a related art;

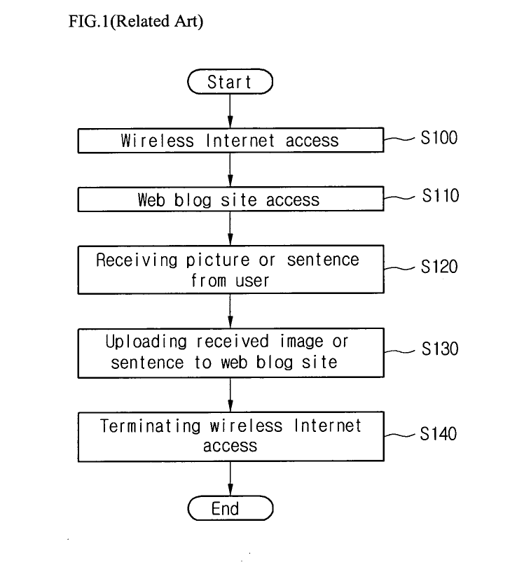

FIG. 2 is a configurational diagram of a web blog upload system in a mobile communication terminal according to a preferred embodiment of the present invention;

FIG. 3 is a block diagram of a mobile communication terminal and computer for a web blog upload according to a preferred embodiment of the present invention;

FIG. 4 is a flowchart of a web blog upload method using a mobile communication terminal according to a preferred embodiment of the present invention;

FIG. 5 is a flowchart of a web blog composing method in a mobile communication terminal according to a preferred embodiment of the present invention;

FIG. 6 is a flowchart of a method of transferring a web blog from a mobile communication terminal to a computer according to a preferred embodiment of the present invention; and

FIG. 7 is a flowchart of a method of uploading web blog contents in a computer according to a preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

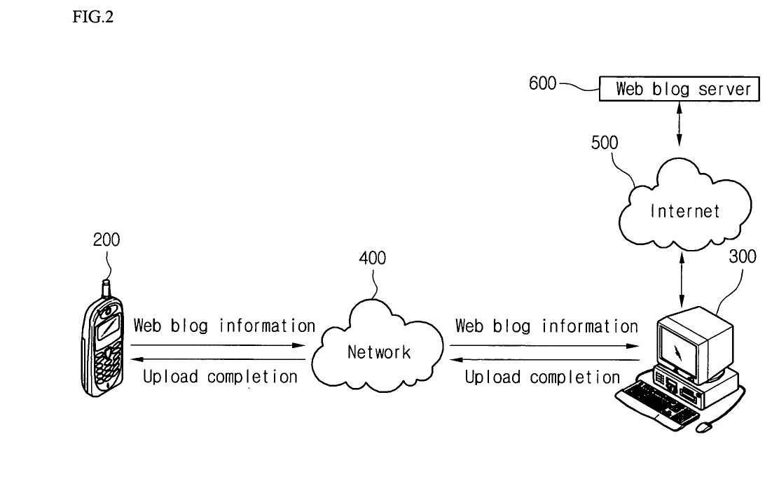

FIG. 2 is a configurational diagram of a web blog upload system in a mobile communication terminal according to a preferred embodiment of the present invention.

Referring to FIG. 2, a web blog upload system in a mobile communication terminal according to a preferred embodiment of the present invention includes a mobile communication terminal 200 for composing, editing and storing a web blog, a personal computer 300, a network 400 connecting the mobile communication terminal 200 and the computer 300 together, and a web blog server 600 existing on Internet 500.

The mobile communication terminal 200 basically performs data and voice communications via a mobile communication network and is capable of composing, editing and storing a user-specific web blog. For this, a programs for composing or editing the web blog is preferably installed in the mobile communication terminal 200, which is named a web blog editor. In this case, various contents of the web blog can be composed by a user and are generally rendered into a web page format using image, text and audio signals.

Once the web blog information is composed, the mobile communication terminal 200 transfers the web bog information to the computer 300 via the network 400.

The computer 300, which is accessible to Internet, receives the web blog information from the mobile communication terminal and then extracts the contents of the web blog and a web blog address for upload from the received web blog information. The computer 300 accesses the web blog server 600 of the Internet 500 according to the extracted web blog address and then uploads the contents of the web blog.

The web blog information includes the contents of the web blog and user information. And, the user information includes a unique terminal number (e.g., phone number), the web blog address as the information for upload, and site authentication information (ID & password). Alternatively, the user information is included in the web blog information to be transferred from the mobile communication terminal or the computer can access the web blog site using previously registered user information without receiving the user information.

The network 400 between the mobile communication terminal 200 and the computer 300 is a local area wireless communication means including wire and/or wireless network. For convenience of explanation, the present invention employs the wireless network. And, this wireless network can be implemented by Bluetooth, UWB (ultra wide band), ZigBee, IrDA, etc.

The mobile communication terminal 200 transfers the previously composed web blog information to the computer 300, and the computer 300 uploads the contents of the web blog to transfer the corresponding result to the mobile communication terminal 200. Hence, a user of the mobile communication terminal can check an upload result of the web blog. In doing so, the user can compose at least one or more web blogs using the mobile communication terminal and can store the composed web blogs in the mobile communication terminal. Once the mobile communication terminal is connected to the computer by attempting a wireless connection automatically in case of a possible local area wireless communication, the information of the stored web blogs can be sequentially transferred.

Moreover, the mobile communication terminal 200 uses synchronization with the computer 300. In the synchronization with the computer 300, a mutual connection between the mobile communication terminal 200 and the computer 300 is automatically tried within a communication range of the local area wireless communication means. If the mutual connection is achieved, the contents of the web blog, which are stored in the mobile communication terminal 200 and are to be uploaded, are automatically transferred to the target computer 300.

Thus, by uploading the composed web blog via the computer 300 using the mobile communication terminal 200, a access to the wireless Internet is unnecessary to avoid paying the wireless Internet use fee or charge.

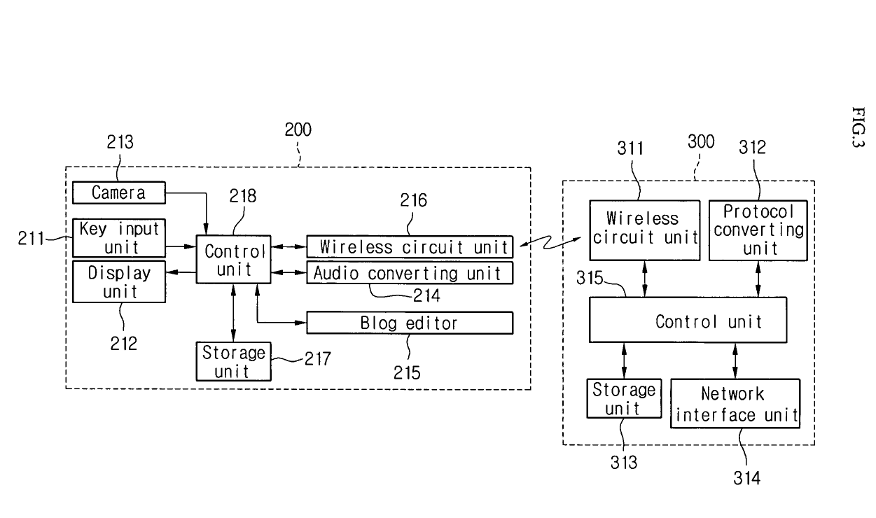

FIG. 3 is a block diagram of a mobile communication terminal and computer for a web blog upload according to a preferred embodiment of the present invention.

Referring to FIG. 3, a mobile communication terminal 200 includes a key input unit 211, a display unit 212, a camera 213, an audio converting unit 214, a web blog editor 215, a wireless circuit unit 216, a storage unit 217, and a control unit 218. The mobile communication terminal 200 transmits web blog information via local area wireless communications and receives an upload result of the transmitted web blog information.

In operating the mobile communication terminal 200, the key input unit 211, which includes a plurality of numeral keys and a plurality of function keys, receives various user's key signals to deliver to the control unit 218. If the web blog editor 215 is selected via the key input unit 211, the web blog editor 215 is driven to be displayed on the display unit 212. So, a user can retrieve and display a previously stored image on a screen and can compose contents of a web blog by inserting sentences, audio and the like on the screen. The contents of the composed web blog are stored in the storage unit 217.

The display unit 212 is controlled by the control unit 218 to visually display a processing of key data inputted via the key input unit 211, a status of the terminal, operational algorithm and the like.

The camera 213 can be built in the mobile communication terminal 200 or can be attached to an outside of the mobile communication terminal 200. And, the camera 213 can acquire an image or moving picture that will be used for the web blog.

The audio converting unit 214 converts an analog voice signal, which is inputted from a microphone, to a digital signal and then transfers the digital signal to the control unit 218. And, the audio converting unit 214 converts a digital voice signal outputted from the control unit 218 to an analog signal to output to a speaker.

The wireless circuit unit 216, which is a local area communication means for synchronization with the computer 300, transmits web blog information to the computer 300 and receives an upload result for the web blog from the computer 300. In this case, the present invention will skip the explanation for a configuration and operation of a wireless communication unit for transmission/reception of voice and data, which are the basic characteristics of the mobile communication terminal.

The storage unit 217 stores information and video data generated from the operational algorithm and operation of the terminal. The storage unit 217 stores contents of the web blog composed by the user.

The control unit 218, which is operative in controlling all functions of the terminal edit, controls editing and storage of the contents of the web blog composed by the user. And, the control unit 218 controls the contents of the web blog to be uploaded with the synchronization with the computer 300.

The computer 300 includes a wireless circuit unit 311, a protocol converting unit 312, a storage unit 313, a network interface unit 314, and a control unit 315.

The wireless circuit unit 311, which is in charge of a physical connection between the mobile communication terminal 200 and the computer 300, transmits/receives data via local area wireless communications to/from the wireless circuit unit 216 of the mobile communication terminal 200. So, the mobile communication terminal 200 can directly control the computer 300 via the wireless circuit units 211 and 311.

The protocol converting unit 312 converts a protocol of the data received from the mobile communication terminal 200. Namely, the protocol converting unit 312 converts the received data to a format that can be stored in the storage unit 313 or to execution data usable by the control unit 315.

The storage unit 313 manages the contents of the web blog transmitted from the mobile communication terminal 200 and data to be transmitted to the mobile communication terminal 200.

The network interface unit 314, which includes a LAN card, access Internet by wire or by wireless.

The control unit 315 decides a service requested from the mobile communication terminal 200 and executes a specific program according to the requested service. And, the control unit 315 analyzes the web blog information received from the mobile communication terminal 200, extracts a web blog address, accesses a site corresponding to the extracted web blog address, and then uploads the contents of the web blog.

An operation of the above-configured web blog upload system using the mobile communication terminal is explained as follows.

First of all, a user of the mobile communication terminal 200 captures an image of a user-specific tour scene or object using the camera 213 and stores the captured image in the mobile communication terminal 200. The stored image is read via the web blog editor 215. The user inputs a text and the like on the web blog screen using the key input unit 211 to edit the web blog and then stores the edited web blog after completion of the editing.

Thereafter, the wireless circuit unit 216 of the mobile communication terminal 200 periodically searches for a communication target. Once the user computer is searched, the wireless circuit units 216 and 311 of the mobile communication terminal 200 and the computer 300 are mutually connected by wireless.

And, the control unit 218 of the mobile communication terminal 200 transmits the web blog information having the user information included in the contents of the stored web blog to the computer 300 via the wireless circuit unit 216.

The computer 300 receives the web blog information, analyzes the received web blog information, and then extracts the contents of the web blog and the user information respectively. The contents of the web blog are temporarily stored in the storage unit 313 and the user information is utilized in accessing the corresponding web blog site. In this case, the user information includes the web blog address, a unique terminal number and authentication information. In case of performing the authentication using either the unique terminal number or the authentication information, the unique terminal number may not be transmitted.

The web blog site is accessed using the web blog address of the user information. The authentication is performed in the web blog site using the authentication information. The contents of the user's web blog are then uploaded. Namely, to upload multimedia data, the contents of the stored web blog are uploaded after the web blog site has been accessed. In this case, the web blog is provided to other bloggers like the ordinary web blogs. Specifically, the uploaded ordinary web blogs are sequentially arranged according to a time basis. The latest is arranged in a most front (upper) line to display both title and contents simultaneously.

Once the upload of the web blog is completed, the computer 300 searches for whether the mobile communication terminal 200 exists within a communication range. If the mobile communication terminal 200 exits within the communication range, the computer 300 transmits a predefined upload completion message to the mobile communication terminal 200. The mobile communication terminal 200 then displays the received upload completion message on the display unit 212 to enable the user to confirm the upload completion. Alternatively, the computer 300 can transmit the upload completion message via a short message service on web using the unique terminal number.

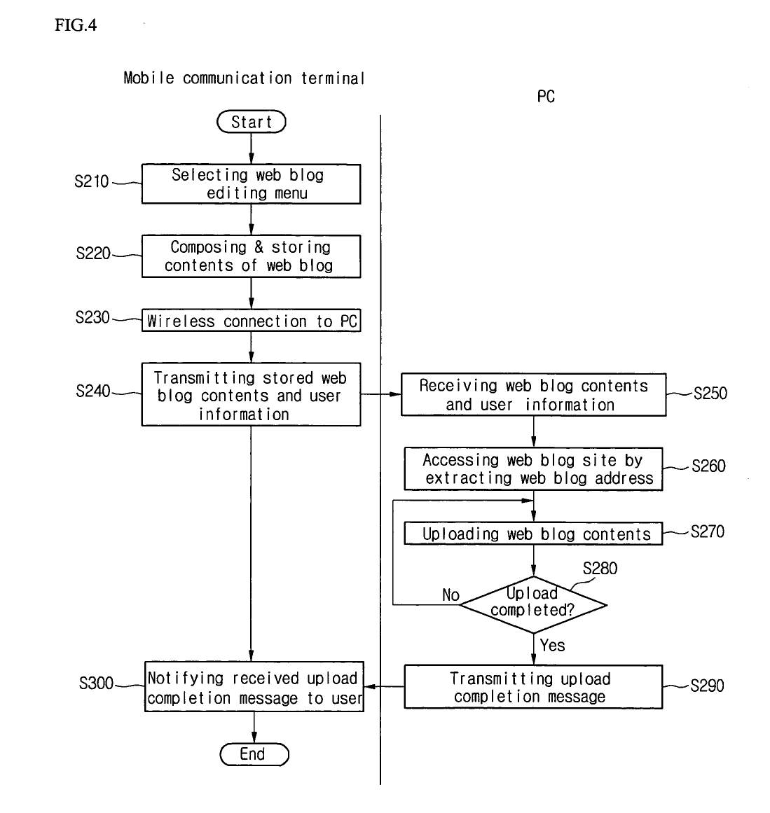

FIG. 4 is a flowchart of a web blog upload method using a mobile communication terminal according to a preferred embodiment of the present invention.

Referring to FIG. 4, if a web blog editing menu is selected by a user in a mobile communication terminal side (S210), a web blog editing image is displayed. The user composes, edits and stores contents of a web blog to be uploaded (S220).

The mobile communication terminal searches for whether the computer lies within a local area wireless communication range. If the computer is searched, the mobile communication terminal attempts a wireless connection to the computer and is then connected to the corresponding computer (S230).

Having connected to the computer by wireless, the mobile communication terminal transmits the contents of the web blog and the user information to the computer (S240). The computer then receives the contents of the web blog and the user information (S250).

The computer accesses the corresponding web blog site according to a web blog address defined in the user information (S260). Having accessed the corresponding web blog site, the computer uploads the contents of the web blog via an authentication process (S270). In doing so, the authentication process is executed using a user ID and password. Optionally, a unique terminal number can be used as the user ID.

Thereafter, once the upload of the contents of the web blog is completed, an upload completion message is transmitted to the mobile communication terminal (S290). The mobile communication terminal then notifies the user of the upload completion message (S300). In doing so, the upload completion message can be transmitted via local area wireless communications. Alternatively, the upload completion message can be notified as a short message service using the terminal number recorded in the user information.

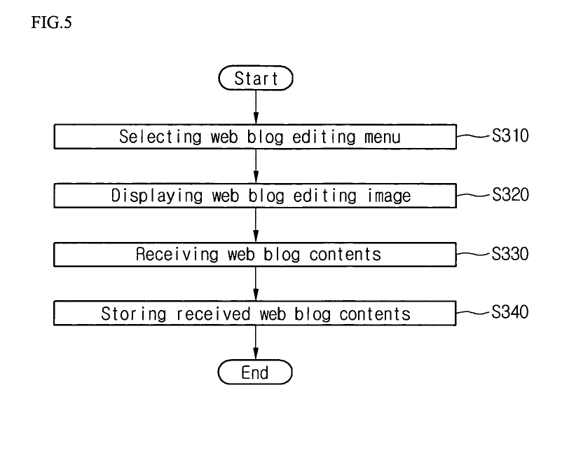

FIG. 5 is a flowchart of a web blog composing method in a mobile communication terminal according to a preferred embodiment of the present invention.

Referring to FIG. 5, it is checked whether a web blog editing menu is selected by a user. If the web blog editing menu is selected (S310), a web blog editor is driven to display a blog editing image (S320).

Subsequently, web blog editing contents composed with image, text and the like are inputted from the user. And, user interfaces including ‘amend’, ‘add’, ‘delete’ and the like are provided to the web blog editing image. In composing a web blog, a specific image is read from an initial web blog editing image or a text is inputted (S330). To edit the composed web blog, a ‘amend’ command is selected. If addition is needed, an ‘add’ command is selected to add contents of the web blog. The contents of the web blog are represented by pictures, sentences and the like.

On the web blog editing image, the contents of the web blog inputted according to a user's ‘store’ command are stored (S340). In doing so, the contents are stored in a web page format.

In case of receiving the web blog editing contents (S604), a mobile communication terminal stores the received contents of the web blog (S606).

At least one or more contents of the web blog can be composed until the mobile communication terminal is connected to a computer via local area wireless communications. Since a final amendment time is reflected on the contents of the composed web blog, the mobile communication terminal compares a final amendment time of the terminal and a final amendment time of the web blog information to automatically decide whether to upload the contents of the web blog.

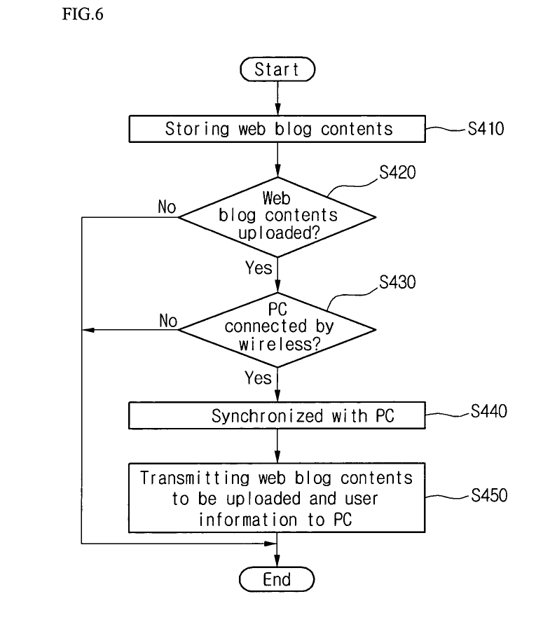

FIG. 6 is a flowchart of a method of transferring a web blog from a mobile communication terminal to a computer according to a preferred embodiment of the present invention.

Referring to FIG. 6, once contents of a web blog are stored (S410), a mobile communication terminal decides whether to upload the contents of the web blog (S420). Namely, by comparing a final amendment time to a final amendment time of the contents of the web blog, the mobile communication terminal finally decides whether to upload the web blog.

As a result of the decision, if there exit the contents of the web blog to be uploaded, the mobile communication terminal decides whether a wireless connection to a computer is possible (S430). Namely, the mobile communication terminal attempts to be connected to the computer by local area wireless communications using local area wireless communication means provided to both of the mobile communication terminal and the computer.

If the mobile communication terminal and the computer are mutually connected by the local area wireless communications, the mobile communication terminal and the computer are synchronized with each other (S440). The mobile communication terminal then transmits the contents of the web blog to be uploaded and user information to the computer (S450). In this case, the user information includes a web blog address, a terminal phone number, authentication information and the like.

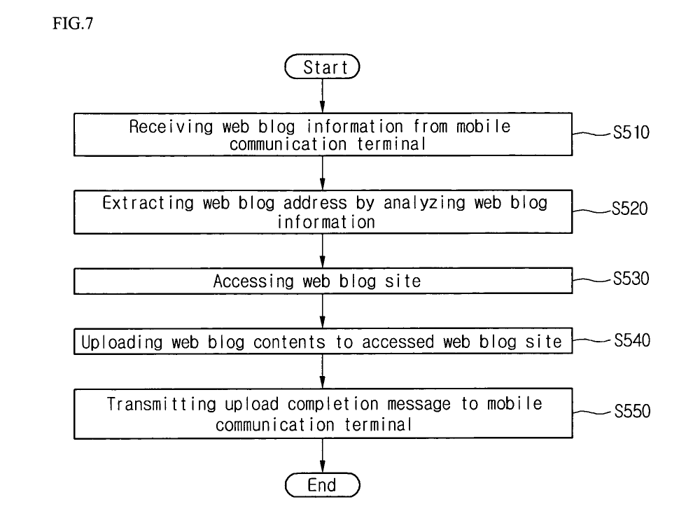

FIG. 7 is a flowchart of a method of uploading web blog contents in a computer according to a preferred embodiment of the present invention.

Referring to FIG. 7, once web blog information is received from a mobile communication terminal (S510), a computer extracts a web blog address by analyzing the received web blog information (S520). In this case, the web blog information includes a web blog address, a phone number and authentication information as well as contents of a web blog.

Once the web blog address is extracted, the computer accesses a web blog site corresponding to the web blog address (S530) and then uploads the contents of the web blog (S540).

Once an upload of the contents of the web blog are uploaded, the computer transmits a predefined upload completion message via local area wireless communications (S550). Alternatively, once the upload of the contents of the web blog is completed, the computer extracts the phone number of the mobile communication terminal and then transmits a predefined upload completion message (e.g., SMS) on the web blog site to the mobile communication terminal using the extracted phone number of the mobile communication terminal via a mobile communication network. So, a user of the mobile communication terminal can confirm the completion of uploading the contents of the web blog.

Meanwhile, as another embodiment of the present invention, the web blog information is transmitted to the computer from the mobile communication terminal. And, the computer can manually upload the contents of the web blog instead of uploading the contents of the web blog automatically according to security or user's choice. And, the automatic or manual upload can be optionally set. Optionally, the web blog information can be transferred not by the automatic wireless connection but by a manual wireless connection between the mobile communication terminal and the computer.

Accordingly, the present invention enables the user to compose the real-time web blog (blog or log) using the mobile communication terminal no matter where she or he is. And, the present invention enables the composed web blog to be uploaded to the corresponding blog site without using the wireless Internet access that costs an associated charge or fee, thereby preventing the waste of radio resources and thereby enhancing the convenience of using the mobile communication terminal.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A web blog upload method using a mobile communication terminal, comprising the steps of:
composing and storing a web blog by off-line in the mobile communication terminal;
searching for a target computer in the mobile communication terminal to be connected to the searched computer by wireless;
transmitting web blog information to the computer connected to the mobile communication terminal by wireless;
analyzing the web blog information received from the mobile communication terminal in the computer; and
uploading the web blog by accessing a user's web blog site.

2. The method of claim 1, the composing and storing step in the mobile communication terminal, comprising the steps of:
displaying a web blog editing image if a web blog editing menu is received from a user; and
allowing the user to compose the web blog and to edit, add or store contents of the composed web blog via the displayed web blog editing image.

3. The method of claim 1, wherein the web blog information includes contents of the stored web blog and a web blog address.

4. The method of claim 1, wherein the mobile communication terminal and the computer performs wireless communications using a local area wireless communication means selected from the group consisting of Bluetooth, ZigBee and UWB.

5. The method of claim 3, wherein the contents of the web blog are represented by an image stored in the mobile communication terminal and/or a sentence inputted by the user.

6. The method of claim 1, the searching step comprising the steps of:
checking a presence or non-presence of a user's web blog to be uploaded to the mobile communication terminal;
searching for the target computer for wireless communications automatically if there exists the user's web blog to be uploaded; and
attempts to perform the wireless communications if the target computer is searched for.

7. The method of claim 1, the web blog uploading step comprising the steps of:
if the web blog information is received from the mobile communication terminal, extracting a user's web blog address by analyzing the received web blog information;
accessing a site corresponding to the extracted web blog address; and
uploading the received web blog to the accessed web blog site.

8. The method of claim 1, further comprising a step of if an upload of the web blog is completed, transmitting an upload completion message to the mobile communication terminal from the computer.

9. The method of claim 8, wherein the upload completion message is transmitted to the mobile communication terminal via Internet.

10. The method of claim 8, wherein the upload completion message is transmitted to the mobile communication terminal by local area wireless communications.

11. A web blog upload method using a mobile communication terminal, comprising the steps of:
composing and storing a web blog by off-line in the mobile communication terminal;
searching for a target computer in the mobile communication terminal to be connected to the searched computer by wireless;
transmitting user's web blog information to the computer connected to the mobile communication terminal by wireless;
analyzing the web blog information received from the mobile communication terminal in the computer and uploading the web blog by accessing a user's web blog site; and
if the computer uploads the web blog, transmitting an upload completion message to the mobile communication terminal.

12. The method of claim 11, wherein the upload completion message is transmitted to the mobile communication terminal via local area wireless communications or Internet according to a presence or non-presence of a local area wireless connection to the mobile communication terminal.

13. The method of claim 11, wherein the web blog comprises a web page including at least one of an image, a text and an audio signal.

14. The method of claim 11, wherein the web blog information comprises contents of the web blog and user information and wherein the user information includes a user's web blog address and corresponding site authentication information.

15. The method of claim 11, wherein if the web blog is stored in the mobile communication terminal, it is decided whether an automatic wireless connection to the computer is possible.

16. A web blog upload system comprising:
a mobile communication terminal automatically transmitting user's web blog information composed by off-line to a target equipment by local area wireless communications;
a computer uploading a web blog by receiving the web blog information from the mobile communication terminal to access a web bog site; and
a web blog server providing the web blog side of the user to a plurality of bloggers.

17. The system of claim 16, the mobile communication terminal comprising:
a web blog editor for composing and editing the user's web blog by off-line;
a storage unit storing the composed web blog therein;
a control unit controlling a search for a wireless communication target if the web blog is generated, the control unit controlling a transmission of the web blog; and
a wireless circuit unit connected to a target computer by wireless for the transmission by local area wireless communications.

18. The system of claim 16, the computer comprising:
a wireless circuit unit for local area wireless communications with the mobile communication terminal;
an analyzing means for extracting contents of the web blog and upload information by analyzing the web blog information received from the wireless circuit unit;
a network interface for accessing the web blog site according to the upload information; and
a control unit for a reception control of the web blog and an upload control of the web blog.

19. The system of claim 16, wherein the web blog information includes contents of the web blog and information for an upload.

20. The system of claim 19, wherein the web blog information includes a phone number of the mobile communication terminal and wherein an upload completion message is transmitted to the mobile communication terminal using the phone number.
